(19) United States
(12) Patent Application Publication
(10) Pub. No.: US 2026/0159422 A1
(43) Pub. Date: Jun. 11, 2026

(54) METHOD FOR PROCESSING CONTAMINATED CARBONACEOUS MATERIAL

(71) Applicant: TALES OF LAND BV, Antwerpen (BE)

(72) Inventors: Gill SCHELTJENS, Wilrijk (BE); David ZIEGLER, Antwerpen (BE)

(21) Appl. No.: 19/126,877

(22) PCT Filed: Nov. 7, 2023
(86) PCT No.: PCT/EP2023/081037

§ 371 Date: May 2, 2025

(30) Foreign Application Priority Data
Nov. 7, 2022 (BE) BE2022/5900

(51) Int. Cl. C02F 1/46; B01J 20/20; C02F 1/28; C02F 101/36

(52) U.S. Cl. CPC C02F 1/4608; B01J 20/20; C02F 1/286; C02F 2101/36

(57) ABSTRACT

The current invention relates to a method for processing contaminated carbonaceous material, said contaminated carbonaceous material comprising a carbonaceous carrier loaded with a contaminate, wherein said contaminate is a halide, a halogenated compound, or a mixture thereof, wherein the method comprises the steps of: (i) providing a process gas to one or more plasma jet generators; (ii) igniting a plasma in the process gas by said plasma jet generators, thereby obtaining a plasma jet comprising reactive species; (iii) introducing the plasma jet into a reaction chamber comprising said contaminated carbonaceous material, thereby allowing said reactive species to decompose said contaminate to halide comprising products; and (iv) extracting product gas from the reaction chamber, said product gas comprising halide comprising products. In another aspect the invention relates to a method and a kit for removal and destruction of a contaminate in water.

### FIELD OF THE INVENTION

The present invention relates to a method for processing contaminated carbonaceous material. In another aspect the invention relates to a method and a kit for removal and destruction of a contaminate in water.

### BACKGROUND

PFAS can enter the environment through the air or through wastewater from factories that use them. They can also enter the environment through the use of fire extinguishers containing PFAS, for example.

PFAS (per- and polyfluoroalkyl substances) are potentially harmful to aquatic organisms. Several studies have shown several effects on organisms that may be related to exposure with PFAS. Because of the potential environmental and health risks, it is important to prevent surface water contamination with these products as much as possible. Unfortunately, it appears that, for example, many firefighting foams end up in surface water through various routes, such as during fire drills, during fires or at a waste disposal facility.

Several studies have been conducted on the removal of PFAS from water. Many PFAS substances are non-volatile, readily soluble in water and persistent in the environment. These properties make cleaning PFAS-contaminated water difficult. PFAS substances are also insensitive to treatment with heat, acids, bases, ozone or UV light and also do not biodegrade. Because they often occur in very low concentrations in water, techniques such as flocculation and sand filtration are not effective.

The use of activated carbon in contaminated (waste) water is currently considered the most effective, workable, and inexpensive method to remove PFAS from wastewater, groundwater and drinking water.

However, the PFAS molecule is still intact when adsorbed on the activated coal. There is need for a destruction method.

Nowadays, thermolysis is the only available technology applied on large scale for the destruction of PFAS solutions. The main drawbacks, however, are that the energy consumption is high as the concentration of PFAS in the water solution is relatively low, and that high temperatures (>850° C.) are required. Furthermore, typical unregular temperature profiles in a furnace are causing incomplete destruction of the PFAS

US 2022/0212959 discloses a method that can be used to degrade a polyfluoroalkyl substance. The main drawback of the invention is the need for spray equipment to form and release the aerosol, which only allows low volumes per unit of time. Furthermore, the method is only directed at treating aqueous liquids, and not solid materials.

WO2021142511A1 describes the processing of PFAS to convert them into safer substances comprises introducing gaseous or vapor phase PFAS into a treatment zone where microwave radiation of predetermined frequency and power level creates a plasma which at least partially dissociates the PFAS. There is also a system for remediating particulate solids, particularly soil, contaminated with PFAS, the method including directing microwave radiation to a body of particulate solids in the closed vessel so as to promote vaporization of PFAS which are then treated by exposure to the microwave produced plasma. The main drawback of the invention is the need for vacuum production, which increases cost of equipment. Furthermore, the method is not directed at treating not solid materials, such as carbonaceous materials.

The present invention aims to resolve at least some of the problems and disadvantages mentioned above.

The invention thereto aims to provide an improved method for processing contaminated carbonaceous material.

### SUMMARY OF THE INVENTION

The present invention and embodiments thereof serve to provide a solution to one or more of above-mentioned disadvantages. To this end, the present invention relates to a method for processing contaminated carbonaceous material according to claim 1. Preferred embodiments of the device are shown in any of the claims 2 to 11.

In a second aspect, the present invention relates to a method according to claim 12 and a kit according to claim 13. A preferred embodiment of the kit is shown in claim 14.

It is a first preferred object of a first aspect of the present invention to provide a method for complete destruction of contaminated carbonaceous material and to convert the contaminants, preferably PFAS, at least partially into safer substances which can improve existing processing or provide at least a useful alternative to existing processing.

It is a second preferred object of a second aspect of the present invention to provide a method for remediating water contaminated with a halide, a halogenated compound, or a mixture thereof, preferably PFAS, which can improve existing remediation processes or provide at least a useful alternative to existing remediation processes.

It is a further preferred object to provide a kit for remediating water contaminated with a halide, a halogenated compound, or a mixture thereof, preferably PFAS, so as to implement the preferred method.

### DETAILED DESCRIPTION OF THE INVENTION

The present invention concerns a method for processing contaminated carbonaceous material.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

The expression “activated carbon”, “active carbon”, “activated (char) coal”, and “active (char) coal”, as used herein, are synonyms and refer to carbon, which is processed to have small, low-volume pores that increase the surface are available for adsorption or chemical reactions. Activation can be achieved by processes known in the art, such as pyrolysis, physical oxidation, chemical oxidation, etc.

The expression “halogenated compound”, as used herein, refers to a chemical compound, onto which at least one halogen (e.g., fluorine, chlorine, bromine, or iodine) has been attached.

The expression “halide”, as used herein, refers to a binary chemical compound, of which one part is a halogen atom and the other part is an element or radical that is less electronegative (or more electropositive) than the halogen, to make a fluoride, chloride, bromide, iodide, astatide, or theoretically tennesside compound.

The expression “halocarbon”, as used herein, refers to a chemical compound wherein one or more carbon atoms are linked by covalent bonds with one or more halogen atoms (fluorine, chlorine, bromine, or iodine) resulting in the formation of organofluorine compounds, organochlorine compounds, organobromine compounds, and organoiodine compounds.

The expression “reactive species”, as used herein, refer to products generated by igniting a plasma when free electrons and active radicals in the plasma interact with molecules at the interface to provide oxidative and reductive species depending on which type of process gas is chosen.

The expression “oxidative species”, as used herein, refer to reactive species (with oxidative capacities.

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention provides a method for processing contaminated material. In a preferred embodiment, said contaminated material comprises a carrier loaded with a contaminate.

In a particularly preferred embodiment, the method comprises the steps of:
i. providing a process gas to one or more plasma jet generators;
ii. igniting a plasma in the process gas by said plasma jet generators, thereby obtaining a plasma jet comprising reactive species;
iii. introducing the plasma jet into a reaction chamber comprising said carrier loaded with a contaminate, thereby allowing said reactive species to decompose said contaminate to decomposition products; and
iv. extracting a product gas from the reaction chamber, said product gas comprising decomposition products.

The method provides for complete destruction of contaminated material and for conversion of the contaminants, preferably PFAS, into safer substances which can improve existing processing or provide at least a useful alternative to existing processing.

The expression “safer substances” used herein, including in the claims, is to be interpreted to encompass not only substances which are less toxic than the contaminate but also substances which can be more readily further processed (chemically, thermally, physically or otherwise) than the contaminate, e.g. by further processing by condensation, chemical reaction, adsorption, filtration, pyrolysis, incineration or thermal treatment.

The term “carrier”, as used herein, refers to any material which can be loaded with a contaminate. In a preferred embodiment, the carrier is a sorbent onto which a contaminate is absorbed or adsorbed. Suitable carriers are for example: activated carbon, anionic exchange resins, zeolites, surface modified clay, coated sand, protein sorbents, cyclodextrin polymer with ionic liquid coated iron (PILI). The carrier is preferentially activated carbon or an anionic exchange resin, with the most preference for activated carbon.

All types of activated carbon can be used in the process of the current invention, such as powdered activated carbon, granular activated carbon, colloidal activated carbon, biochar, carbon nanotubes, extruded activated carbon (EAC), bead activated carbon (BAC), impregnated carbon, polymer coated carbon.

In a preferred embodiment, the contaminated material is a contaminated carbonaceous material, meaning the carrier is a carbonaceous carrier, preferably the carrier is activated carbon, more preferably the carrier is granular activated carbon, colloidal activated caron, biochar, carbon nanotubes, or a mixture thereof, with preference for granular activated carbon.

In a particularly preferred embodiment, the invention provides a method for processing contaminated carbonaceous material, wherein said contaminated carbonaceous material comprises a carbonaceous carrier loaded with a contaminate.

The contaminate can comprise any contaminate which is soluble in water. In a preferred embodiment the contaminate comprises a halogenated compound, and preferably the contaminate is a halide, a halocarbon, or a mixture thereof, such as, but not limited to, a polyfluoroalkyl substance, a perfluoroalkyl substance, perfluorooctanoic acid, an organic dye including linear, aliphatic, and aromatic dyes, Rhodamine (C28H31N2O3Cl), and Luminol (C8H7N3O2). In an advantageous embodiment, the contaminate comprises per- and poly-fluoroalkyl substances (referred to herein as PFAS).

The reactive species in the plasma jet and/or plasma jet afterglow have shown to influence the defluorination of PFASs. The active free electrons, and radicals attack the SOOH/COOH functional group of PFAS, initiating HF elimination reactions to subsequently reduce the PFAS. PFAS can undergo chain shortening processes via decarboxylation, hydroxylation, elimination, hydrolysis, by losing CO, or by losing SO2, or any combination, which leads to defluorination. Furthermore, during such decomposition/defluorination, elimination of groups from the evolving fluorocarbons can also be facilitated by such electrons. PFAS as a contaminate will result in halogen comprising products as decomposition products.

In step (i) of the method, there is provided a process gas to one or more plasma jet generators. The process gas provided in step (i) can comprise any gas chosen from the list of: CO₂, O₂, air, N₂, noble gases, or a mixture thereof. The process gas may be flue gas, waste gas from combustion, CO₂, CO, CH₄, H₂, and/or any combinations thereof, including impurities such as H₂O and SO₂. In a preferred embodiment the process gas comprises CO₂, O₂, or a mixture thereof. In a more preferred embodiment, the process gas comprises CO₂. In an even more preferred embodiment, the process gas is substantially CO₂. In an alternative even more preferred embodiment of the invention, the process gas comprises more than 20% by weight, preferably more than 40% CO₂ by weight, more preferably more than 50% CO₂ by weight, more preferably more than 60% CO₂ by weight, more preferably more than 70% CO₂ by weight, more preferably more than 80% CO₂ by weight, more preferably more than 90% CO₂ by weight, more preferably more than 95% CO₂ by weight, more preferably more than 96% CO₂ by weight, more preferably more than 97% CO₂ by weight, more preferably more than 98% CO₂ by weight, more preferably more than 99% CO₂ by weight. CO₂ and/or O₂ present in the process gas is advantageous as the plasma jet will comprise oxidative species (such as oxygen radicals) as reactive species. CO₂ is particularly advantageous as it is a greenhouse gas.

In an alternative even more preferred embodiment of the invention, the process gas comprises more than 0.5% CO₂ by weight, preferably more than 1% CO₂ by weight, more preferably more than 2% CO₂ by weight, more preferably more than 3% CO₂ by weight, more preferably more than 4% CO₂ by weight, more preferably more than 5% CO₂ by weight, more preferably more than 6% CO₂ by weight, more preferably more than 7% CO₂ by weight, more preferably more than 8% CO₂ by weight, more preferably more than 9% CO₂ by weight, more preferably more than 10% CO₂ by weight, more preferably more than 11% CO₂ by weight, more preferably more than 12% CO₂ by weight, more preferably more than 13% CO₂ by weight, preferably more than 14% CO₂ by weight, more preferably more than 15% CO₂ by weight, more preferably more than 20% CO₂ by weight, preferably more than 40% CO₂ by weight, more preferably more than 50% CO2 by weight, more preferably more than 60% CO2 by weight, more preferably more than 70% CO2 by weight, more preferably more than 80% CO2 by weight, more preferably more than 90% CO2 by weight, more preferably more than 95% CO2 by weight, more preferably more than 96% CO2 by weight, more preferably more than 97% CO2 by weight, more preferably more than 98% CO2 by weight, more preferably more than 99% CO2 by weight.

Furthermore, the conversion of CO2 leads to CO, which is a base in (petro)chemical and steelmaking industry. In addition, if the contaminated material comprises a carbonaceous material, this carbonaceous material can aid in fixating the excess oxygen from the CO2 to CO conversion according to the following reaction scheme:

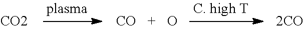

This advantageously allows for the plasma to dissociate the contaminate and convert CO2 towards CO at higher yields than in the absence of a carbonaceous, contaminated carrier. As a result the combination of CO2 to CO plasma conversion and carbonaceous absorption of contamination, followed by plasma destruction thereof provides synergies. The dissociation of the carbonaceous carrier improves the CO2 to CO conversion and yield; the dissociation of CO2 provides strong oxidative species which improve the breakdown of the contaminate.

The plasma ignited in step (ii) is preferably suitable to ignited by an atmospheric plasma jet technology.

In a preferred embodiment, the plasma jet generators provided in step (i) to ignite the plasma in step (ii) are chosen from the list of: gliding arc (GA), glow discharge (GD), microwave discharge (MW), radiofrequency discharge (RF), capacitive coupled discharge (CCD) or dielectric barrier discharge, preferably gliding arc (GA) or glow discharge (GD), most preferably gliding arc.

These plasma jet generators differ in their main performance characteristics, i.e. conversion and energy efficiency, as discussed below.

GA is a medium to high-powered (500-800 W) atmospheric plasma source, with established conversion performance ˜6-7% (for pure CO₂ splitting) and energy efficiency up to 32%, and 15% conversion with 65% energy efficiency for dry reforming of methane.

GD is a low to medium-powered (100-200 W) atmospheric plasma reactor. In its lab scale (shown below), the CO₂ conversion reaches around 13% with energy efficiency of 25%. The APGD can deliver higher conversion (around 13%), but its energy efficiency is limited (25%). However, the lower energy efficiency is not a limiting factor in all cases. In a situation where heat recovery is desirable, the lower energy efficiency means that more heat will be available to be recovered from the gas and supplemented to the main process. Furthermore, if the electricity price is low at a given moment (peak trimming of renewable sources), the lower energy efficiency becomes less of a problem (see below), while the high conversion is beneficial.

Since the GA, and the GD can run on the same type of power source, the system of the present invention may preferably comprise a combination of the three variations. Fundamentally, the three reactor technologies are very similar, so the end goal is a reactor that offers their best performance metrics.

Preferably, the plasma jet is obtained at about atmospheric pressure. Atmospheric pressure refers to a pressure close to 1 atm, preferably between 500 and 5000 hPa, more preferably at least 900 hPa, still more preferably at least 950 hPa, and/or more preferably at most 1100 hPa, still more preferably at most 1070 hPa, most preferably between 970 hPa and 1050 hPa, such as around 1013 hPa.

In a preferred embodiment, the plasma jet generators are two or more plasma jet generators, which are preferably operated in parallel.

The expression “plasma reactor”, as used herein, comprises:
a reaction chamber, which optionally may be suitable to be pressurized; and
one or more plasma jet generators.

In a preferred embodiment, said plasma reactor comprises two or more plasma jet generators, more preferably comprising a multitude of similarly, preferably equally, sized plasma jet generators suitable for parallel operation. Upscaling plasma reactors is often difficult and problematic due to the non-linear nature of atmospheric plasmas. Advantageously, the plasma reactor may comprise a stack of similarly sized plasma jet generators operating in parallel. The plasma jet generators may advantageously be connected to a single reaction chamber. In an alternative preferred embodiment, the plasma reactor comprises, preferably consists of, a stack of at least 2, more preferably at least 3, more preferably at least 4, more preferably at least 5, more preferably at least 6, more preferably at least 8, more preferably at least 10, more preferably at least 12, more preferably at least 14, most preferably at least 16 similarly sized, preferably equally sized, plasma jet generators connected to operate in parallel. In a further or another preferred embodiment, the plasma reactor comprises, preferably consists of, a stack of at most 50, more preferably at most 40, more preferably at most 30, more preferably at most 25, most preferably at most 20 similarly sized, preferably equally sized, plasma reactor modules connected to operate in parallel. In a preferred embodiment multiple plasma jet generators are connected to a single reaction chamber.

In step (ii) of the method, a plasma is ignited in the process gas by said plasma jet generators, thereby obtaining a plasma jet comprising reactive species. In a preferred embodiment, said reactive species are oxidative species, in an even more preferred embodiment, said reactive species are CO and O species.

In an embodiment, the method comprises the step of introducing reducing agents, such as H₂, in the process gas, in the plasma jet, or in both. In a preferred embodiment, the method comprises the step of introducing H₂, as reducing agent, in the process gas, in the plasma jet, or in both.

In step (iii) of the method, the plasma jet is introduced into a reaction chamber comprising the contaminated material, which is a carrier loaded with a contaminate, thereby allowing said reactive species to decompose said contaminate to decomposition products.

Step (ii) and step (iii) are preferably sequential.

The type of resulting decomposition products is dependent on the contaminate loaded on the carrier. In a preferred embodiment, the decomposition products are halogen comprising products, such as, but not limited to, hydrogen fluoride (HF).

Preferably, the reaction chamber comprises the afterglow region of the plasma jet and/or preferably the contaminated material, preferably the carbonaceous contaminated material, in the reaction chamber is subjected to the afterglow region of the plasma jet. Advantageously, the heat as well as presence of highly reactive species is utilized to improve the reaction equilibrium and reaction kinetics of the decomposition of the contaminate.

Preferably, the afterglow region is optimized in length. This can preferably be achieved by using a volumetric flow of process gas between 10 and 1000 standard liters per minute per individual plasma jet generator. Furthermore, the afterglow region can be optimized by adjusting the plasma reactor power, in a range between 100 and 100,000 W per individual plasma jet generator.

In a preferred embodiment of the invention, the contaminated material, preferably the contaminated carbonaceous material, are particles in the form of a fine powder. These can be preferably supplied through an additional inlet with a carrier gas, such as air, or together with the main process gas supply. The methods will most likely differ, as one will aid conversion in the post-plasma region (additional inlet), and the other will influence the plasma chemistry in the discharge itself. For instance, carbon particles in the plasma may facilitate faster contaminate decomposition, but, on the other hand, consume molecular oxygen (O), which normally contributes to the CO₂ splitting process (neutral impacts).

In a particularly preferred embodiment of the invention, the contaminated material, preferably the contaminated carbonaceous material, is in a fluidized state. In another embodiment, the contaminated material, preferably the contaminated carbonaceous material, is positioned in a fixed bed.

In fixed bed mode, the contaminated material, preferably the contaminated carbonaceous material, preferably has particle sizes with an average radius between 0.1 and 50 mm. Most preferably, an average radius between 0.5 and 5 mm. In fluidized bed mode, the carbon particles preferably have sizes with an average radius between 5 and 5000 μm. Most preferably, an average radius between 5 and 500 μm.

In a particular, preferred embodiment of the invention, the carbon reaction chamber is a fluidized bed reactor configured to fluidize the carbon donor particles. In a further preferred embodiment, the system comprises a continuous feed of contaminated material, preferably said continuous feed of contaminated material is a gravity-driven silo, rotating screw, conveyer belt or a combination thereof; suitable to provide the fluidized bed with carbon donor particles. This advantageously allows fully continuous operation.

In step (iii) of the method, product gas is extracted from the reaction chamber, said product gas comprising halide comprising products, preferably HF.

In an embodiment, the method further comprises the step of bubbling the product gas through an alkaline solution. This will separate and neutralize the components in the product gas.

For example, if the process gas comprises CO₂, CO will be formed and will not dissolve into the alkaline solution and as such can be recovered. The halide comprising products, such as HF will be neutralized and dissolve in the solution.

The alkaline solution comprises preferentially water and a base, preferably an alkali. “Base” as used herein refers to a substance capable of accepting or neutralizing hydrogen ions. “Alkali” as used herein refers to a base that dissolves in water.

The base, preferably alkali can be any inorganic hydroxide or inorganic oxide, such as sodium hydroxide (NaOH), potassium hydroxide (KOH), calcium hydroxide (Ca(OH)₂), calcium oxide (CaO), magnesium hydroxide (Mg(OH)2), magnesium oxide (MgO), or a mixture thereof, preferably Ca(OH)₂, or a mixture thereof.

For example, if Ca(OH)₂ is used as base, the neutralization will be:

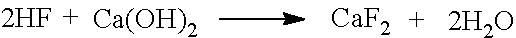

This process is based on the principle of contact precipitation and can thus be introduced for the removal of fluoride ions from water.

In a preferred embodiment, the decomposition products comprise safer substances than the contaminate, preferably the decomposition products comprise halogen comprising products, more preferably the decomposition products comprise hydrogen fluoride (HF).

In a particularly preferred embodiment of the invention, the contaminated material is a carbonaceous carrier loaded with PFAS, wherein the method comprises the steps of:
i. providing a process gas comprising CO₂ to one or more plasma jet generators;
ii. igniting a plasma in the process gas by said plasma jet generators, thereby obtaining a plasma jet comprising oxidative species;
iii. introducing the plasma jet into a reaction chamber comprising said contaminated carbonaceous material, thereby allowing said oxidative species to decompose said PFAS, at least partially, to hydrogen fluoride; and
iv. extracting product gas from the reaction chamber, said product gas comprising hydrogen fluoride.

In this embodiment, plasma jet technology, preferably atmospheric plasma jet technology, is combined with the carbonaceous carrier for the industrial conversion of CO₂ to CO. Hereby, the plasma-splitting of the CO₂ molecules is done in an environment where the CO radicals cannot immediately recombine with the oxygen radicals as these will be trapped even faster by the carbonaceous material, in the plasma area and/or plasma afterglow area. This is for instance achieved by activating the CO₂ with the proper-energy plasma in a carbon bed of small particles of carbon, thus:

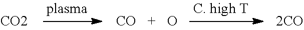

The concept is to add the contaminated material, preferably the contaminated carbonaceous material, to the process in a reaction chamber. In this configuration, the activated O can be made to contact the added carbon and thus efficiently react with it to form CO. The carbonaceous material may preferably be activated coal, carbon nanotubes, cokes, or any combination thereof. The process gas streams can preferably be continuous. In an embodiment, at least a part of the resulting product gas may be recycled and fed into the same or another plasma reactor together with additional, fresh process gas comprising CO₂.

This embodiment comprises the step of converting the CO₂ into CO using the reversible Boudouard reaction. The reversible Boudouard reaction is used to convert CO₂ to CO based on the addition of carbonaceous material at high temperatures of at least 800° C. Advantageously, the heat drives the oxygen fixation in the carbon bed.

In the present embodiment, these reactive species may be ionized species of O, CO, CO2, O, CO, CO₂ radicals, excited neutral or charged O, CO, CO₂ species, or any combination or mixture thereof. Preferably, the plasma jet afterglow comprises CO radicals and/or oxygen (O) radicals.

In a particularly preferred embodiment the method is a method for processing contaminated carbonaceous material, said contaminated carbonaceous material comprising a carbonaceous carrier loaded with a contaminate, wherein said contaminate is a halide, a halocarbon, or a mixture thereof, preferably said contaminate comprises per- and poly-fluoroalkyl substances, and wherein said carbonaceous carrier is preferably activated carbon, more preferably said carbonaceous carrier is granular activated carbon, wherein the method comprises the steps of:
i. providing a process gas to one or more plasma jet generators;
ii. igniting a plasma in the process gas by said plasma jet generators, thereby obtaining a plasma jet comprising reactive species;
iii. introducing the plasma jet into a reaction chamber comprising said contaminated carbonaceous material, thereby allowing said reactive species to decompose said contaminate to halogen comprising products, wherein the process gas preferably comprises CO2, more preferably more than 20% by weight, even more preferably more than 40%, CO2 by weight; and
iv. extracting product gas from the reaction chamber, said product gas comprising halogen comprising products.

In a further particularly preferred embodiment the method is a method for processing contaminated carbonaceous material, said contaminated carbonaceous material comprising a carbonaceous carrier loaded with a contaminate, wherein said contaminate comprises per- and poly-fluoroalkyl substances, and wherein said carbonaceous carrier is activated carbon, preferably said carbonaceous carrier is granular activated carbon, wherein the method comprises the steps of:
i. providing a process gas to one or more plasma jet generators;
ii. igniting a plasma in the process gas by said plasma jet generators, thereby obtaining a plasma jet comprising reactive species;
iii. introducing the plasma jet into a reaction chamber comprising said contaminated carbonaceous material, thereby allowing said reactive species to decompose said contaminate to halogen comprising products, wherein the process gas comprises CO2, more preferably more than 20% by weight CO2 by weight, even more preferably more than 40% CO2 by weight; and
iv. extracting product gas from the reaction chamber, said product gas comprising halogen comprising products.

In another particularly preferred embodiment the method is a method for processing contaminated carbonaceous material, said contaminated carbonaceous material comprising a carbonaceous carrier loaded with a contaminate, wherein said contaminate is a halide, a halocarbon, or a mixture thereof, preferably the contaminate comprises per- and poly-fluoroalkyl substances, and wherein said carbonaceous carrier is preferably activated carbon, more preferably said carbonaceous carrier is granular activated carbon, colloidal activated caron, biochar, carbon nanotubes, or a mixture thereof, with preference for granular activated carbon, wherein the method comprises the steps of:
i. providing a process gas to one or more plasma jet generators;
ii. igniting a plasma in the process gas by said plasma jet generators, thereby obtaining a plasma jet comprising reactive species;
iii. introducing the plasma jet into a reaction chamber comprising said contaminated carbonaceous material, thereby allowing said reactive species to decompose said contaminate to halogen comprising products, wherein the process gas preferably comprises CO₂, more preferably more than 20% by weight CO₂ by weight, more preferably more than 40% CO₂ by weight; and
iv. extracting product gas from the reaction chamber, said product gas comprising halogen comprising products;
V. bubbling said product gas through an alkaline solution.

In a further particularly preferred embodiment the method is a method for processing contaminated carbonaceous material, said contaminated carbonaceous material comprising a carbonaceous carrier loaded with a contaminate, wherein said contaminate comprises per- and poly-fluoroalkyl substances, and wherein said carbonaceous carrier is activated carbon, preferably said carbonaceous carrier is granular activated carbon, wherein the method comprises the steps of:
i. providing a process gas to one or more plasma jet generators;
ii. igniting a plasma in the process gas by said plasma jet generators, thereby obtaining a plasma jet comprising reactive species;
iii. introducing the plasma jet into a reaction chamber comprising said contaminated carbonaceous material, thereby allowing said reactive species to decompose said contaminate to halogen comprising products, wherein the process gas comprises CO2, preferably more than 20% by weight CO2 by weight, more preferably more than 40% CO₂ by weight; and
iv. extracting product gas from the reaction chamber, said product gas comprising halogen comprising products;
V. bubbling said product gas through an alkaline solution.

In a second aspect, the invention provides a method for remediating water contaminated with a contaminate.

The contaminate can comprise any contaminate which is soluble in water. In a preferred embodiment the contaminate comprises a halogenated compound, and preferably the contaminate is a halide, a halocarbon, or a mixture thereof, such as, but not limited to, a polyfluoroalkyl substance, a perfluoroalkyl substance, perfluorooctanoic acid, an organic dye including linear, aliphatic, and aromatic dyes, Rhodamine (C28H31N2O3Cl), and Luminol (C8H7N3O2). In an advantageous embodiment, the contaminate comprises per- and poly-fluoroalkyl substances (referred to herein as PFAS).

In a preferred embodiment, the method comprises the steps of:
a. providing a carrier, preferably a carbonaceous carrier, in said water, thereby loading the carrier, preferably the carbonaceous carrier, with said contaminate;
b. processing said carrier, preferably said carbonaceous carrier, loaded with said contaminate by a method according to the first aspect, wherein said carrier, preferably said carbonaceous carrier, and said contaminate are both decomposed.

In a preferred embodiment, the carrier is a sorbent onto which the contaminate absorbs or adsorbs, thereby removing the contaminate from the water. Suitable carriers are for example: activated carbon, anionic exchange resins, zeolites, surface modified clay, coated sand, protein sorbents, cyclodextrin polymer with ionic liquid coated iron (PILI). The carrier is preferentially activated carbon or an anionic exchange resin, with the most preference for activated carbon.

It has been found that activated carbon results in the highest adsorption of the contaminate, preferably PFAS, from the water. Furthermore, the carbon in the carbon carrier can be used as carbon donor particles in the subsequent plasma treatment.

In a particularly preferred embodiment, the contaminate is PFAS, and the method comprises the steps of:
providing a carbonaceous carrier, preferably activated carbon, in said water, thereby loading the carbonaceous carrier, preferably activated carbon, with PFAS;
processing said carbonaceous carrier, preferably activated carbon, loaded with PFAS by a method according to the first aspect of the invention, wherein said carbonaceous carrier, preferably activated carbon, and said PFAS are both decomposed.

In a third aspect, the invention relates to a kit for remediating water contaminated with a contaminate.

In a particularly preferred embodiment, the kit comprises a carbonaceous carrier and a plasma reactor.

Said plasma reactor preferably comprises:
a reaction chamber comprising a gas inlet and a gas outlet,
one or more plasma jet generators comprising:
   a. a process gas inlet suitable for supplying the plasma jet generator with process gas,
   b. a plasma jet outlet in fluid communication with the gas inlet of the reaction chamber, and
   c. a set of electrodes suitable for igniting a plasma in the process gas.

In a preferred embodiment, the plasma jet generators are two or more plasma jet generators, which are preferably positioned in parallel.

In a preferred embodiment, the plasma said one or more plasma jet generators are two or more plasma jet generators comprising a multitude of similarly, preferably equally, sized plasma jet generators suitable for parallel operation. Upscaling plasma reactors is often difficult and problematic due to the non-linear nature of atmospheric plasmas. Advantageously, the plasma reactor may comprise a stack of similarly sized plasma jet generators suitable for operating in parallel. The plasma jet generators may advantageously be connected to a single reaction chamber. In an alternative preferred embodiment, the plasma reactor comprises, preferably consists of, a stack of at least 2, more preferably at least 3, more preferably at least 4, more preferably at least 5, more preferably at least 6, more preferably at least 8, more preferably at least 10, more preferably at least 12, more preferably at least 14, most preferably at least 16 similarly sized, preferably equally sized, plasma jet generators connected to operate in parallel. In a further or another preferred embodiment, the plasma reactor comprises, preferably consists of, a stack of at most 50, more preferably at most 40, more preferably at most 30, more preferably at most 25, most preferably at most 20 similarly sized, preferably equally sized, plasma reactor modules connected to operate in parallel. In a preferred embodiment multiple plasma jet generators are connected to said one reaction chamber.

In a preferred embodiment, the kit is suitable for carrying out a method according to the second aspect of the invention.

The invention is further described by the following non-limiting examples which further illustrate the invention, and are not intended to, nor should they be interpreted to, limit the scope of the invention.

### EXAMPLES AND DESCRIPTION OF FIGURES

The present invention will now be further exemplified with reference to the following examples. The present invention is in no way limited to the given examples or to the embodiments presented in the figures.

### Example 1

Example 1 refers to a method for remediating water contaminated with PFAS according to a second aspect of the invention.

In a first step PFAS is removed from the water with granular activated carbon as a carrier. PFAS can be almost completely removed from the water with the activated carbon. It was not previously expected that the PFAS with short chains from for example extinguishing foam would also adsorb to a very high degree, but the method is also effective for these substances.

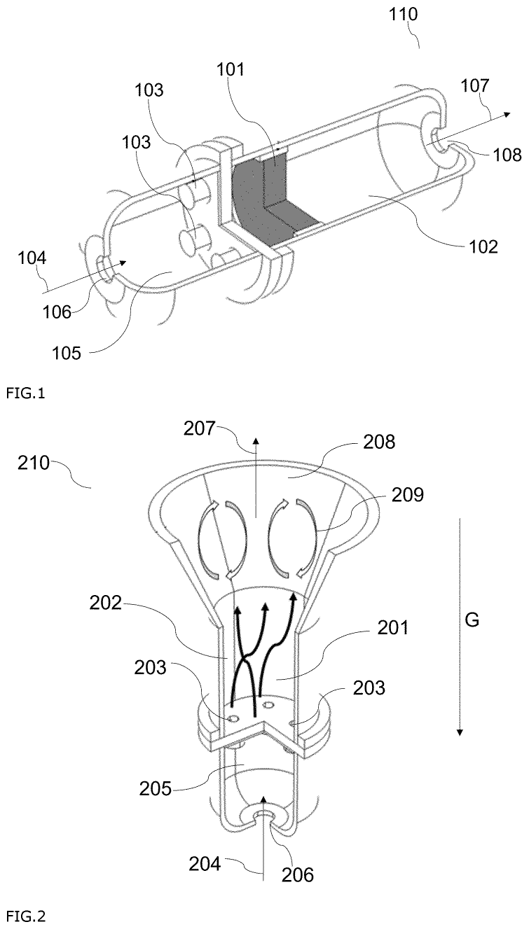

The granular activated carbon onto which the still intact PFAS molecules are adsorbed is processed in a second step of the method according to a processing method according to the first aspect of the invention. To better exemplify reference is made to FIG. 1, which shows a cross-sectional view of a fixed bed plasma reactor (110) for the destruction of PFAS adsorbed on activated carbon. The contaminated granular activated carbon (101) is added to a reaction chamber (102) as a fixed bed, which is positioned downstream to multiple non-thermal plasma jet generators (103). The non-thermal plasma jet generators (103) are based on a gliding arc plasma technology, where the multiple gliding arcs are operating in parallel to allow scaling of this type of technology, and as such the treatment of larger quantities of contaminated activated carbon.

A process gas comprising CO₂ (104) is provided through a gas inlet (106) to the plasma jet generators (103) via a pressure chamber (105). A plasma is ignited in the process gas (104), thereby obtaining a plasma jet comprising CO and O species. The afterglow of the plasma jet is introduced in the reaction chamber (102) comprising the PFAS contaminated activated carbon (101), thereby allowing said CO and O species to decompose the PFAS, wherein the CO and O species attack the SOOH/COOH functional group of PFAS, initiating HF elimination reactions to subsequently reduce the PFAS. PFAS can undergo chain shortening processes via decarboxylation, hydroxylation, elimination, hydrolysis, by losing CO, or by losing SO2, or any combination, which leads to defluorination. Furthermore, during such decomposition/defluorination, elimination of groups from the evolving fluorocarbons can also be facilitated by such electrons. A product gas (107) is formed comprising decomposition products, which are mainly CO and HF.

The product gas (107) is extracted from the reaction chamber (102) through a gas outlet (108).

In a third step of the method, the product gas (107) is bubbled through an alkaline solution to split/neutralize the components present in the product gas (107). The CO will not dissolve into the alkaline solution and can be recovered, the HF will be neutralized and dissolve in the solution. For example, if Ca(OH)₂ is used as base, the neutralization will be:

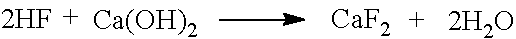

The technique involves the addition of calcium compounds to the raw water will precipitate the fluoride ions as CaF₂, which can be recovered.

### Example 2

Example 2 refers to a method for remediating water contaminated with PFAS according to a second aspect of the invention.

In a first step PFAS is removed from the water with granular activated carbon as a carrier. PFAS can be almost completely removed from the water with the activated carbon. It was not previously expected that the PFAS with short chains from for example extinguishing foam would also adsorb to a very high degree, but the method is also effective for these substances.

The granular activated carbon onto which the still intact PFAS molecules are adsorbed is processed in a second step of the method according to a processing method according to the first aspect of the invention. To better exemplify reference is made to FIG. 2, which shows a fluidized bed plasma reactor (210) for the destruction of PFAS adsorbed on activated carbon. The contaminated granular activated carbon (201) is added to a reaction chamber (202) as a fluidized bed, which is positioned downstream to multiple non-thermal plasma jet generators (203). Particles of the fluidized bed recirculate (209) in the reaction chamber (202). The non-thermal plasma jet generators (203) are based on a gliding arc plasma technology, where the multiple gliding arcs are operating in parallel to allow scaling of this type of technology, and as such the treatment of larger quantities of contaminated activated carbon.

A process gas comprising CO₂ (204) is provided through a gas inlet (206) to the plasma jet generators (203) via a pressure chamber (205). A plasma is ignited in the process gas (204), thereby obtaining a plasma jet comprising CO and O species. The afterglow of the plasma jet is introduced in the reaction chamber (202) comprising the PFAS contaminated activated carbon (201), thereby allowing said CO and O species to decompose the PFAS, wherein the CO and O species attack the SOOH/COOH functional group of PFAS, initiating HF elimination reactions to subsequently reduce the PFAS. PFAS can undergo chain shortening processes via decarboxylation, hydroxylation, elimination, hydrolysis, by losing CO, or by losing SO2, or any combination, which leads to defluorination. Furthermore, during such decomposition/defluorination, elimination of groups from the evolving fluorocarbons can also be facilitated by such electrons. A product gas (207) is formed comprising decomposition products, which are mainly CO and HF.

The product gas (207) is extracted from the reaction chamber (202) through a gas outlet (208).

In a third step of the method, the product gas (207) is bubbled through an alkaline solution to split/neutralize the components present in the product gas (207). The CO will not dissolve into the alkaline solution and can be recovered, the HF will be neutralized and dissolve in the solution. For example, if Ca(OH)₂ is used as base, the neutralization will be:

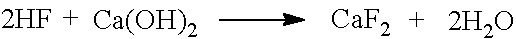

The technique involves the addition of calcium compounds to the raw water will precipitate the fluoride ions as CaF₂, which can be recovered.

### Example 3

Example 3 refers to a method for remediating water contaminated with PFAS according to a second aspect of the invention.

In a first step PFAS is removed from the water with granular activated carbon as a carrier. PFAS can be almost completely removed from the water with the activated carbon. It was not previously expected that the PFAS with short chains from for example extinguishing foam would also adsorb to a very high degree, but the method is also effective for these substances.

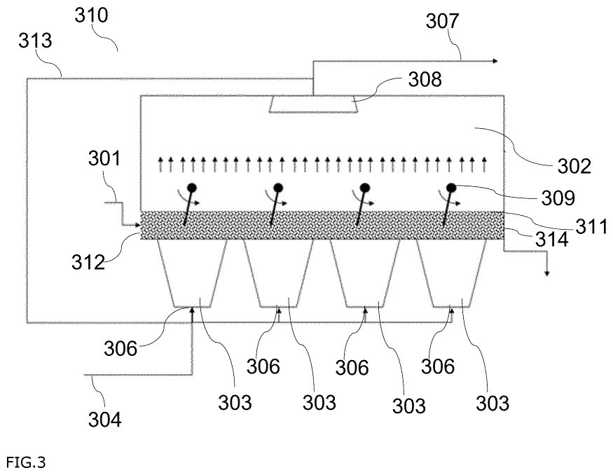

The granular activated carbon onto which the still intact PFAS molecules are adsorbed is processed in a second step of the method according to a processing method according to the first aspect of the invention. To better exemplify reference is made to FIG. 3, which shows a continuous fluidized bed plasma reactor (310) for the destruction of PFAS adsorbed on activated carbon. The contaminated granular activated carbon (301) is added through a carbon inlet (312) to a reaction chamber (302) as a continuous fluidized bed (311), which is positioned downstream to multiple non-thermal plasma jet generators (303). Particles of the fluidized bed (311) are transported through the reaction chamber (302) via a transport system (309) in the reaction chamber (302) to a carbon outlet (314). The non-thermal plasma jet generators (303) are based on a gliding arc plasma technology, where the multiple gliding arcs are operating in parallel to allow scaling of this type of technology, and as such the treatment of larger quantities of contaminated activated carbon.

A process gas comprising CO₂ (304) is provided through gas inlets (306) to the plasma jet generators (303). A plasma is ignited in the process gas (304), thereby obtaining a plasma jet comprising CO and O species. The afterglow of the plasma jet is introduced in the reaction chamber (302) comprising the PFAS contaminated activated carbon (301), thereby allowing said CO and O species to decompose the PFAS, wherein the CO and O species attack the SOOH/COOH functional group of PFAS, initiating HF elimination reactions to subsequently reduce the PFAS. PFAS can undergo chain shortening processes via decarboxylation, hydroxylation, elimination, hydrolysis, by losing CO, or by losing SO₂, or any combination, which leads to defluorination. Furthermore, during such decomposition/defluorination, elimination of groups from the evolving fluorocarbons can also be facilitated by such electrons. A product gas (307) is formed comprising decomposition products, which are mainly CO and HF.

The product gas (207) is extracted from the reaction chamber (302) through a gas outlet (208). In another embodiment, a part of the product gas (207) is extracted from the reaction chamber (302) through a gas outlet (208), while the rest of the product gas (207) is recirculated (313) to the plasma jet generators (303)

In a third step of the method, the product gas (307) is bubbled through an alkaline solution to split/neutralize the components present in the product gas (307). The CO will not dissolve into the alkaline solution and can be recovered, the HF will be neutralized and dissolve in the solution. For example, if Ca(OH)₂ is used as base, the neutralization will be:

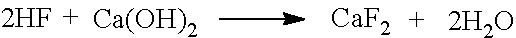

The technique involves the addition of calcium compounds to the raw water will precipitate the fluoride ions as CaF₂, which can be recovered.

It is supposed that the present invention is not restricted to any form of realization described previously and that some modifications can be added to the presented example of fabrication without reappraisal of the appended claims. For example, the present invention has been described referring to PFAS adsorbed on granular activated carbon, but it is clear that the invention can be applied to any contaminate for instance or to any carrier.

The present invention is in no way limited to the embodiments described in the examples and/or shown in the figures. On the contrary, methods according to the present invention may be realized in many different ways without departing from the scope of the invention.

1. A method for processing contaminated carbonaceous material, wherein the method comprises:
providing a process gas to one or more plasma jet generators;
igniting a plasma in the process gas by said plasma jet generators, thereby obtaining a plasma jet comprising reactive species;
introducing the plasma jet into a reaction chamber comprising said contaminated carbonaceous material, said contaminated carbonaceous material comprising a carbonaceous carrier loaded with a contaminate, wherein said contaminate is a halide, a halocarbon, or a mixture thereof, the introducing thereby allowing said reactive species to decompose said contaminate to halogen comprising products; and
extracting product gas from the reaction chamber, said product gas comprising halogen comprising products.

2. The method according to claim 1, wherein the process gas comprises more than 1% CO₂ by weight.

3. The method according to claim 1, wherein the carbonaceous carrier is activated carbon.

4. The method according to claim 1, wherein the contaminate comprises per- and poly-fluoroalkyl compounds (PFAS).

5. The method according to claim 1, wherein the process gas comprises CO₂, O₂, air, N₂, noble gases, or a mixture thereof.

6. The method according to claim 1, wherein the method further comprises bubbling said product gas through an alkaline solution.

7. The method according to claim 6, wherein said alkaline solution, comprises Ca(OH)₂.

8. The method according to claim 1, wherein the one or more plasma jet generators are chosen from gliding arc (GA), glow discharge (GD), microwave discharge (MW), radiofrequency discharge (RF), capacitive coupled discharge (CCD) or dielectric barrier discharge.

9. The method according to claim 1, wherein the plasma jet generators are two or more plasma jet generators.

10. The method according to claim 1, wherein the method comprises introducing reducing agents; in the process gas, and/or in the plasma jet.

11. The method according to claim 1, wherein the contaminated carbonaceous material is in a fluidized state.

12. The method according to claim 1, wherein said contaminate is adsorbed or absorbed on said carbonaceous carrier.

13. A method for remediating water contaminated with a contaminate, wherein the method comprises the steps of:
providing a carbonaceous carrier in said water, thereby loading the carbonaceous carrier with said contaminate, wherein said contaminate is a halide, a halocarbon, or a mixture thereof;
processing said carbonaceous carrier loaded with said contaminate by a method according to claim 1, wherein said carbonaceous carrier and said contaminate are both decomposed.

14. A kit for remediating water contaminated with a contaminate, wherein the kit comprises a carbonaceous carrier and a plasma reactor, wherein the plasma reactor comprises:
a reaction chamber comprising a gas inlet and a gas outlet, and
one or more plasma jet generators comprising:
a process gas inlet suitable for supplying the plasma jet generator with process gas,
a plasma jet outlet in fluid communication with the gas inlet of the reaction chamber, and
a set of electrodes suitable for igniting a plasma in the process gas.

15. The kit according to claim 14, wherein the plasma reactor comprises two or more plasma jet generators.

16. The method according to claim 5, wherein the process gas comprises CO₂.

17. The method according to claim 8, wherein the one or more plasma jet generators are chosen from the gliding arc (GA) or the glow discharge (GD).

18. The method according to claim 17, wherein the one or more plasma jet generators are chosen from the gliding arc.

19. The method according to claim 9, wherein the plasma jet generators are operated in parallel.

20. The method according to claim 10, wherein the reducing agents include H₂.
